(19) United States
(12) Patent Application Publication
(10) Pub. No.: US 2021/0035454 A1
(43) Pub. Date: Feb. 4, 2021

(54) REMOTE AIRCRAFT IDENTIFICATION FOR UAV

(71) Applicant: FLARM TECHNOLOGY AG, Cham (CH)

(72) Inventors: Urban Mäder, Ebertswil (CH); Andrea Boris Schlapbach Käppeli, Hausen am Albis (CH)

(21) Appl. No.: 16/639,439

(22) PCT Filed: Aug. 13, 2018
(86) PCT No.: PCT/EP2018/071888

§ 371 Date: Feb. 14, 2020

(30) Foreign Application Priority Data
Aug. 15, 2017 (CH) 01024/17

(51) Int. Cl. G08G 5/00; G01S 19/49; G05D 1/10; H04W 84/06; H04W 12/00; H04W 12/04; H04W 12/12; B64D 43/00

(52) U.S. Cl. CPC G08G 5/0013; G01S 19/49; G08G 5/0017; G05D 1/101; B64D 43/00; H04W 12/009; H04W 12/04033; H04W 12/1204; H04W 84/06

(57) ABSTRACT

A remote identification device (10) for a multirotor (1) comprises an EGNOS enabled GPS receiver (11) for determining a three-dimensional position (P) of the aircraft (1) and a radio transmitter (12) operating at 2.4 GHz for periodically transmitting a data package (D) comprising the determined three-dimensional position (P) of the aircraft (1), a unique identifier (ID) of the aircraft (1), and a timestamp. The transmitted data packages (D) comprise first types (D1) carrying the full information as well as second types (D2) carrying only relative position data. All data packages (D) further comprise ECC data and are cryptographically signed. Remote identification devices (10, 10′) on different aircrafts (1,1′) together with the ground based receiver station (ATC) form a mesh-network by retransmitting foreign data packages. Thus, aircrafts (1,1′) are more easily identified and the data packages can be efficiently used for aircraft registration and law enforcement.

### CROSS-REFERENCE TO RELATED APPLICATION

This is the United States national phase of International Patent Application PCT/EP2018/071888, filed Aug. 13, 2018, which claims priority to CH 01024/17, filed on Aug. 15, 2017, the entire contents of each of which are incorporated herein by reference.

### TECHNICAL FIELD

The invention relates to a device, system, and method for remote identification of an aircraft, in particular of an unmanned aircraft (UA) such as a multirotor. A further aspect of the invention relates to an aircraft comprising such a remote identification device.

### BACKGROUND ART

Recently, unmanned aircrafts such as multirotors become more and more widespread, which raises both security, safety, and accountability concerns for individuals, aircraft, authorities and regulators. The question of identifiability of these aircraft and accountability to responsible persons or entities becomes a key enabler for this technology, e.g., in case of an incident such as an airspace or privacy violation or damage on ground.

Known and widespread solutions for large aircraft such as SSR transponders or ADS-B OUT are not suitable for these types, dynamics and numbers of aircrafts and do not provide the required information.

### DISCLOSURE OF THE INVENTION

The problem to be solved by the present invention is therefore to provide a device, system, aircraft and method that at least in part overcomes these disadvantages.

This problem is solved by the device, aircraft, method, and system of the independent claims.

Accordingly, as a first aspect of the invention, a remote identification device for an unmanned aircraft comprises a positioning device for determining a three-dimensional position of the aircraft and a transmitter for periodically transmitting a data package comprising the determined three-dimensional position of the aircraft and an identifier of the aircraft. Thus, the aircraft is easier to identify and follow over time from a distance which improves the security and safety for airspace users and third persons alike. This is similar to a license-plate approach/vehicle registration requirement in road traffic which leads both to an improved driver behavior as well as to identifiability of misbehaving drivers and thus improves overall road safety. Similarly, here, the information in the transmitted data packages enables the determination of which aircraft is at which position at what time. This contributes to overall security and safety.

In a preferred embodiment, the positioning device comprises a global navigation satellite system (GNSS) receiver, in particular at least one of a Global Positioning System (GPS) receiver, a Global Navigation Satellite System (GLONASS) receiver, a Galileo receiver, and a Beidou receiver. More preferred, the positioning device comprises a differential GNSS receiver such as at least one of a Wide Area Augmentation System (WAAS) receiver, a European Geostationary Navigation Overlay Service (EGNOS) receiver, and a Multi-Functional Satellite Augmentation System (MSAS) receiver. Thus, the three-dimensional position of the aircraft is more easily and precisely to determine.

In other preferred embodiments, the positioning device comprises an Inertial Navigation System (INS) and/or a receiver for its own position data (P) (i.e., its own three-dimensional position) from a ground-based localization system. Thus, the three-dimensional position of the aircraft is more easily and precisely to determine.

Advantageously, the remote identification device is structured for receiving an interrogation request from another aircraft or from a ground-based station, in particular from air traffic control (ATC) or another authority. Then, the data package is advantageously transmitted after receiving the interrogation request, which enables automated on-demand identification of the aircraft.

In another preferred embodiment, the remote identification device is structured for encrypting and/or cryptographically signing at least a part of said data package, in particular using an asymmetric and/or a symmetric algorithm. Thus, the authenticity and/or validity and/or correct transmission and/or privacy of the data package is easier to guarantee or verify which increases overall safety.

Preferably, in such an embodiment, the remote identification device further comprises a security device, in particular comprising at least one key (e.g., a digital string of characters, number, signs, etc.). Then the security device is structured for encrypting and/or cryptographically signing at least said part of said data package. Thus, computational load can be taken away from other devices and battery power is saved. Furthermore, the security device comprise a protection device against malicious access or extraction, e.g., of the key and/or the data package. Thus, the “identity” is fixed to the single remote identification device. Preferably, each identification device has its own unique identity (in addition to its unique identifier as discussed above), e.g., in form of a unique key for encryption and/or signature. This helps to ensure that the “identity” of the remote identification device (and thus of the aircraft) cannot be easily stolen or forged from other users which helps to improve the authenticity and/or validity and/or correct transmission and/or privacy of the data package. This increases overall safety.

Yet more preferable, in such embodiments, the remote identification device is structured for asymmetrically encrypting and/or signing at least said part of said data package, i.e., using said asymmetric algorithm. Then, the security device preferably comprises a private key used for this asymmetric encryption and/or signing, which helps to ensure that the “identity” of the remote identification device (and thus of the aircraft) cannot be easily stolen or forged from other users. A public key as used for decryption and/or verification of the data package is preferably stored in a central database (i.e., certificate authority (CA)), e.g., on a central server which can or cannot be part of the remote identification device. Typically, such a central database is arranged at an authority such as air traffic control and it can comprise further information such as user registration of different aircraft and/or insurance data. This improves identifiability and increases overall safety.

In yet another preferred embodiment, the data package further comprises at least one of
a request for clearance and/or an acknowledgement of clearance, e.g., for crossing a restricted airspace,
a parameter of the aircraft, in particular a fuel level and/or a battery level, e.g., indicative of an available range of the aircraft,
a planned and/or expected future flight trajectory of the aircraft, e.g., for flight planning purposes in densely populated airspaces,
a mission status of the aircraft, e.g., indicative of a mission achievement or goal,
a collision avoidance dataset, in particular a FLARM dataset, and
a current date and/or timestamp, i.e., indicative of a transmission time/date and/or an age of the transmitted data package.

Thus, more information is obtained from the aircraft which improves overall safety.

In yet another advantageous embodiment, the identifier of the aircraft is a unique identifier. This enables unique identification of the aircraft which enhances overall safety due to traceability.

Preferably, the identifier of the aircraft comprises a fixed part and a user-configurable part. This enables unique aircraft identification on the one hand and also leaves room for additional user-configured information, e.g., for the purpose of fleet-management or licensing purposes.

In another advantageous embodiment, the remote identification device is structured for transmitting the data package
with a fixed periodicity, i.e., at fixed time-intervals, e.g., every 5 seconds,
with a variable periodicity, i.e., at variable time-intervals depending on different parameters,
with a variable periodicity based on the three-dimensional position of the aircraft,
with a variable periodicity based on a velocity of the aircraft for, e.g., transmitting a data package more frequently the higher the velocity of the aircraft is,
with a variable periodicity based on an acceleration of the aircraft,
with a variable periodicity based on a travelled distance of the aircraft, in particular a travelled distance after a previous transmitted data package, for, e.g., transmitting a data package every 100 m of a flight trajectory,
with a variable periodicity based on a distance of the aircraft to an external position, in particular to an airspace or a landmark, e.g., the data packages are transmitted more frequently the nearer the aircraft comes to a restricted airspace, e.g., around an official airport,
with a variable periodicity based on a NOTAM information or an ATC clearance, e.g., indicative of non-permanent airspace restrictions,
with a variable periodicity based on an air traffic or radio traffic density, and/or
with a variable periodicity based on at least one of a mission profile, a risk profile (e.g., due to a weight of the aircraft), and a threat level (e.g., due to mass gatherings).

In these cases, additional receivers and/or sensors can be foreseen which measure relevant parameters such as air traffic density. As an effect, more information is obtainable from the transmitted data packages by the aircraft which improves overall safety.

Advantageous periodicities are:
data package transmission rate is one update every 5 GNSS seconds,
the maximum data package transmission rate is one update per GNSS second and may not be exceeded under any circumstance,
a remote identification device must send one update per GNSS second when and only when one of the following events occurs:
   take-off,
   landing,
   movement of more than 50 m in any direction relative to last update
   latest update is 5 seconds old.

Advantageously, the remote identification device is structured for transmitting said data package
at a frequency of approximately 868 MHz, i.e., 868 MHz±10%,
at a frequency of approximately 915 MHz, i.e., 915 MHz±10%,
at a frequency of approximately 2.4 GHz, i.e., 2.4 GHz±5%,
at a frequency of approximately 5.8 GHz, i.e., 5.8 GHz±5%,
using an ultra-wideband (UWB) transmitter,
using a GFSK modulation,
using a maximum output power of 25 mW, and/or
using a bitrate of 100 kbps.

This enables the reliable transmission of the data packages using available analogue and/or digital radio technology which helps to reduce costs and simplify the device.

In another preferred embodiment, the remote identification device is structured for transmitting at least a first type of the data package and a second type of the data package. Then, the first type of the data package (type-1 data package) comprises the determined three-dimensional position of the aircraft and the identifier of the aircraft, and the second type of the data package (type-2 data package) comprises a relative position of the aircraft with regard to the three-dimensional position of the aircraft as transmitted in the first type of said data package or with regard to a three-dimensional position of the aircraft previously transmitted in a second type of said data package. Then, the transmitted data package sequence can, e.g., comprise a type-1 data package transmitted every 1 minute with a type-2 data packages transmitted every 10 seconds in between the type-1 data packages. Also variable periodicities for both the type-1 and the type-2 data packages as well as for the number of type-2 packages between two type-1 packages are possible. In other words, preferably, a first periodicity for the first type of said data package is the same or different from a second periodicity for the second type of said data package. Such a “keyframe-approach” helps to reduce bandwidth which is highly relevant in densely populated airspaces with many transmitting aircrafts.

In an advantageous embodiment of the remote identification device, at least a part, in particular an altitude, of the transmitted three-dimensional position of the aircraft in the data package comprises a relative position, in particular with regard to
an altitude above ground (AGL),
an altitude above WGS-84 geoid, or
a takeoff site of the aircraft.

As another example, leading coordinates of the latitude and/or longitude of the lateral coordinates can be truncated for low-range aircrafts such as multirotors, because, e.g., there is no doubt about the continent the aircraft operates on.

This helps to reduce bandwidth which is highly relevant in densely populated airspaces with many transmitting aircrafts.

In yet another preferred embodiment, the remote identification device is structured to encode the three-dimensional position in the data package using Longitude Compression. This technique is based on the following: With an increasing latitude, the resolution for the longitude decreases. As an example, at 0° N, one bit of longitude corresponds to 1E-7°. At 60° N the resolution is 2E-7° (for locally obtaining the same East/West resolution). The graduation can take place in discrete steps or via a fixed function. The goal of this technique is to save a few bits in the longitude in the data package, or to simplify processing on the receiving side.

This helps to reduce bandwidth which is highly relevant in densely populated airspaces with many transmitting aircrafts.

Advantageously, the remote identification device comprises a radio traffic limiting device, in particular a frequency hopping device, a time slot synchronization device, a listen-before-talk device, and/or a fair spectrum management device. ETSI EN 300 220-1 provides additional details.

As an example implementation, the remote identification device may be required to sense for existing carriers before transmitting. If a carrier is detected, transmission of the data package must be delayed. The remote identification device may retry transmission after a random delay selected from the interval 15 ms-150 ms. Data packages must be discarded after a total delay of 1000 ms is exceeded from the initial transmission attempt. If no packet can be transmitted 3000 ms after the initial attempt, the device may force transmission irrespective of carrier detect. After a forced attempt, the device is required to not transmit for at least 2000 ms.

This helps to reduce bandwidth which is highly relevant in densely populated airspaces with many transmitting aircrafts.

Preferably, the remote identification device is structured for periodically transmitting said data package to a mobile or stationary ground-based station, in particular to air traffic control. Thus, the aircraft identifier and position can be monitored and/or interrogated from the ground, e.g., by authorities, which helps to enhance overall security and safety.

In a preferred embodiment, the remote identification device comprises an airborne unit, i.e., a unit arranged at a to-be-identified aircraft, and a ground-based unit, e.g., connected to an electronic flight controller of the aircraft. The airborne unit and the ground-based unit are communicatively connected to each other. Then, preferably, the ground-based unit is structured for periodically transmitting said data package, in particular to air traffic control, in particular via a wireless connection, in particular via a cellphone data connection over the internet, e.g., through a flight control app running on a smartphone and connected to or comprising the ground-based unit. Thus, the more energy intensive transmission of the data package can be achieved through the ground-based unit which helps to conserve battery of the aircraft.

The remote identification device advantageously comprise a recording device structured for recording and storing at least one of the transmitted data packages, in particular all transmitted data packages. Thus, the transmitted data package(s) can be logged and stored, e.g., for later archiving or further analysis, e.g., for evidence purposes in case of an incident.

Advantageously, the remote identification device is structured in such a way that at least a part of said data package is Manchester coded. By using such a form of self-clocking, lower error rates and a more reliable transmission is achieved. The reduced transfer rate can be tolerated for data packages which are longer than 1 byte.

In another preferred embodiment, the remote identification device is structured in such a way that the transmitted data package comprises error-detection data, in particular a hash or a checksum. Thus, a detection of wrongly received data packages is achieved on the receiver side which enables lower error rates and a more reliable transmission, e.g., through requests for retransmission of such data packages.

Alternatively or in addition, the data package preferably comprises error-correcting data, e.g., in the form of error-correcting codes (ECC). This additional information to the payload enables correction of wrongly received data packages on the receiver side, see e.g., U.S. Pat. No. 5,446,747 for details. This enables lower error rates and a more reliable transmission for the time-critical and bandwidth consuming transmitted data packages and reduces requests for retransmission of such data packages.

In another preferred embodiment, the remote identification device is structured in such a way that the transmitted data package comprises data received from another remote identification device, in particular data indicative of an identifier (or a truncated version thereof such as a hash-value), an absolute or relative three-dimensional position, a distance, a Received Signal Strength Indicator (RSSI), a bearing vector, a timestamp, and/or an age. Thus, more information is obtained from the aircrafts operating in the same or neighboring airspaces which improves overall security and safety. Further, an option for self-check of the transmission can more easily be implemented.

In yet another advantageous embodiment, the remote identification device is structured to retransmit data received from another remote identification device, in particular for creating a mesh network of remote identification devices. Thus, more information is obtained from the aircrafts operating in the same or neighboring airspaces which improves overall security and safety.

Advantageously, in such an embodiment, the remote identification device is further structured to add additional data to a retransmitted data package, in particular a number of retransmissions. Thus, e.g., infinite looping can more efficiently be avoided which helps to save bandwidth, in particular for densely populated airspaces.

Advantageously, in such an embodiment, the remote identification device is structured to retransmit the data received from the other remote identification device using a different frequency or technology, in particular ADS-R or TIS-B. Particularly, the data received from the other remote identification device is transformed, amended, truncated, or converted before retransmission. This helps to make the aircraft visible to air traffic participants using different technologies, e.g., transponders in commercial airplanes. Thus, the overall safety is enhanced.

In another advantageous embodiment, the remote identification device comprises an interface unit for exchanging data with a flight controller of the aircraft, e.g., a battery level or bearing, which additional information can also be comprised in or used for the data package.

In yet another advantageous embodiment, the remote identification device is structured to apply a field encoding and condensing to at least a part of the data package. This helps to reduce bandwidth which is highly relevant in densely populated airspaces with many transmitting aircrafts.

As another aspect of the invention, an aircraft comprises a remote identification device as described above. Thus, the aircraft is more easily identifiable which helps to increase security and safety.

Preferably, the is selected from the group of an Unmanned Aerial Vehicle (UAV), a drone, an Unmanned Aircraft System (UAS), a Remotely Piloted Aircraft Systems (RPAS), a multirotor, a human passenger carrying UAV, and a weather balloon. Thus, a broader range of aircrafts becomes more easily identifiable which helps to increase security and safety.

In an advantageous embodiment, the aircraft is selected from the group of a fully autonomous aircraft, a partially autonomous aircraft, a temporarily autonomous aircraft, a ground-controlled aircraft with a visual link to a pilot, and a ground-controlled aircraft without a visual link to a pilot. The aircraft can be in a line-of-sight of an, e.g., ground-based pilot or not. Thus, a broader range of aircrafts becomes more easily identifiable which helps to increase security and safety.

In another advantageous embodiment, the aircraft is an unmanned aircraft wherein no human pilot is aboard the aircraft. Thus, a broader range of aircrafts becomes more easily identifiable which helps to increase security and safety.

As another aspect of the invention, a method for remotely identifying an aircraft, in particular an aircraft as described above, in particular using a remote identification device as described above, comprises the steps of:
by means of a positioning device determining a three-dimensional position of the aircraft,
by means of a transmitter periodically transmitting a data package comprising the determined three-dimensional position of the aircraft and an identifier of the aircraft. Thus, the aircraft is more easily identifiable which helps to increase security and safety.

Advantageously, the method comprises further steps of:
receiving said transmitted data package (D) by a mobile or stationary receiver station, in particular a ground-station, and
identifying said aircraft (1) using said received data package (D).

Thus, the aircraft is more easily identifiable which helps to increase security and safety.

In a preferred embodiment, the method comprises a further step of:
determining information relating to a missing or faulty data package using one or more previously received data packages, in particular using an extrapolation of a trajectory. Thus, the information is readily available despite the data package being missing or faulty, which leads to improved situational awareness thus contributing to security and safety.

In a preferred embodiment, the method comprises at least one of the steps of:
saving said data package, in particular by means of a receiver station e.g., for later retrieval and/or logging,
analyzing and/or processing said data package, in particular by means of a receiver station, and
retransmitting said data package (D), in particular wirelessly retransmitting said data package, in particular by means of a receiver station.

Thus, the information can be more easily evaluated and/or spread which helps to improve situational awareness thus contributing to security and safety.

In another preferred embodiment of the method, said data package is used for at least one of
aircraft fleet management,
liability assessment,
law enforcement purposes,
evidence purposes,
billing,
air traffic management and/or regulation,
performance assessment, in particular pilot performance assessment,
aircraft registration, and
an aircraft logbook.

This helps to save costs and leads to improved security and safety

As yet another aspect of the invention, a system for remote identification of an unmanned aircraft is disclosed, in particular using a method as described above, the system comprising:
a first remote identification device as described above and arranged at a first aircraft, in particular an aircraft as described above, and
a mobile or stationary receiver station for receiving the transmitted data package from the first remote identification device.

This receiver station advantageously comprises a ground-based station, in particular air traffic control (ATC) or a second aircraft, the second aircraft in particular comprising a second remote identification device as described above.

Thus, the aircraft is more easily identifiable which helps to increase security and safety.

In a preferred embodiment of the system, at least two remote identification devices, in particular as described above, are arranged as a mesh-network. This means that one remote identification device retransmits data received from another remote identification device and thereby creates an extended range network of remote identification devices. The receiver station can also be part of this network. This leads to increased range and improved information distribution which eventually helps to improve situational awareness thus contributing to security and safety.

In another preferred embodiment, the system further comprises a central database comprising the identifier and owner information. Preferably, this central database also comprises the certificate authority for decryption and/or validation of the data packages. Thus, the relevant information can be accessed via this database which simplifies analysis.

### Definitions

The term “unmanned” as used herein relates to any flying object without a human pilot on board, regardless of its construction, purpose, size, weight, cargo, movement dynamics, principle and propulsion to stay airborne and move around or eventual tethering. Such flying objects may be remotely controlled, in or outside the visual sight of a remote pilot, or operate partially or temporarily or fully automated. It may include autonomous or cooperative elements to sense, detect and avoid other objects on the ground or in the air, e.g., sensors, cameras, LIDAR, RADAR, . . . .

Note:

The described embodiments likewise refer to the device claims, the aircraft claims, the method claims, and the system claims. As it is apparent to the person skilled in the art, synergistic effects may arise from the combination of features of different embodiments, although these may not be described in detail.

### BRIEF DESCRIPTION OF THE DRAWINGS

The invention will be better understood and objects other than those set forth above will become apparent when consideration is given to the following detailed description thereof. This description makes reference to the annexed drawings, wherein:

FIG. 1 shows a first multirotor 1 comprising a first remote identification device 10 and a second multirotor 1′ comprising a second remote identification device 10′ according to a first embodiment of the invention,

FIG. 2 shows a first multirotor 1 comprising a first remote identification device 10 according to a second embodiment of the invention,

FIG. 3 shows a first example of a data package D as transmitted by a remote identification device 10 according to the invention,

FIG. 4 shows a second example of a data package D as transmitted by a remote identification device 10 according to the invention,

FIGS. 5a and 5b show a third example of a first type D1 and a second type D2 of data packages as transmitted by a remote identification device 10 according to the invention,

FIG. 6 shows a payload structure of the data package D, and

FIG. 7 shows a lookup table as used for field encoding and condensing as explained with regard to FIG. 6.

### MODES FOR CARRYING OUT THE INVENTION

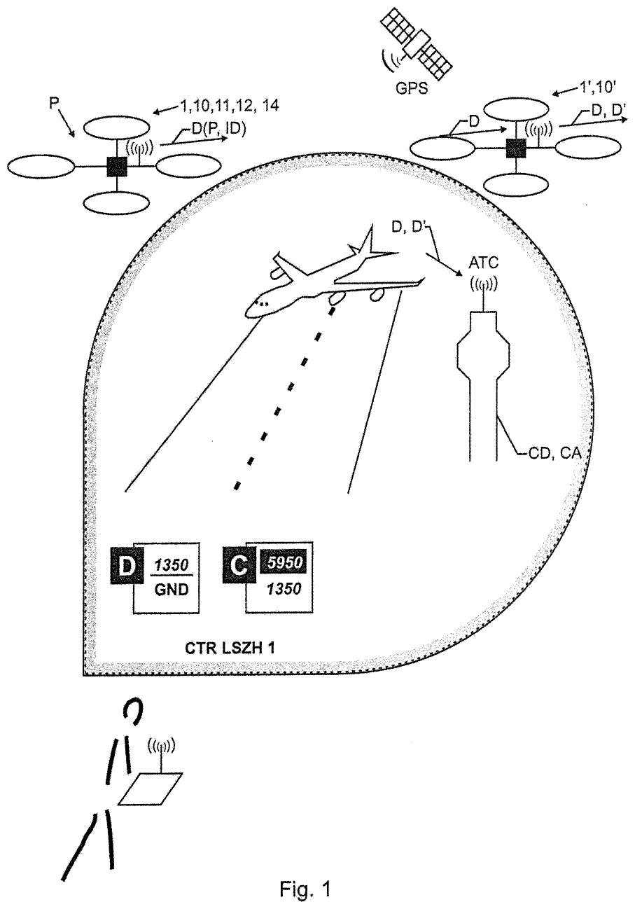

FIG. 1 shows a first multirotor 1 comprising a first remote identification device 10 and a second multirotor 1′ comprising a second remote identification device 10′ according to a first embodiment of the invention. The first multirotor 1 is a ground-controlled UAV and it comprises an EGNOS enabled GPS receiver 11 (one GPS satellite shown for clarity) for determining its three-dimensional position P. It further comprises a 2.4 GHz transceiver 12 for—in additional to receiving control signals from the electronic flight controller in the pilot's hands on the ground (only schematically shown) and sending status data and a video image down to the flight controller—periodically transmitting data packages D comprising the multirotor's current position P and a unique identifier ID. In addition, air traffic control ATC can send an interrogation request which is then replied to with a data packages D comprising the multirotor's current position P and its unique identifier ID. The sent packages are cryptographically signed by means of a security device 14 and comprise ECC data (not shown) and a timestamp. Data packages are more frequently sent (i.e., with a faster peridicity) the closer the multicopter gets to a restricted airspace (shown here as CTR LSZH 1 control zone comprising a class D and a class C airspace). Furthermore, the second multirotor 1′ shown in FIG. 1 in addition to sending its own data packages D′ receives and retransmits the data packages from the first multirotor 1, thus creating a mesh network. This helps to increase range, in particular in situations in which no high radio powers can be used for reasons of bandwidths limitations and many air traffic participants. As an alternative or in addition thereto, a fair spectrum management device, e.g., a listen before talk device can be used (not shown). The received data packages D, D′ from the first multirotor 1 and the second multirotor 1′, respectively, are saved at ATC and analyzed for evidence purposes in case of an airspace violation of the control zone by the drone pilot. In such a case, a warning is also issued to commercial airplane pilots by ATC (only schematically shown). This increases safety by preventing mid-air collision. ATC further has access to a central database CD including a certificate authority CA for verification of the signed data packages as well as owner information. Thus, a system for remote identification of an unmanned aircraft is created by the various components.

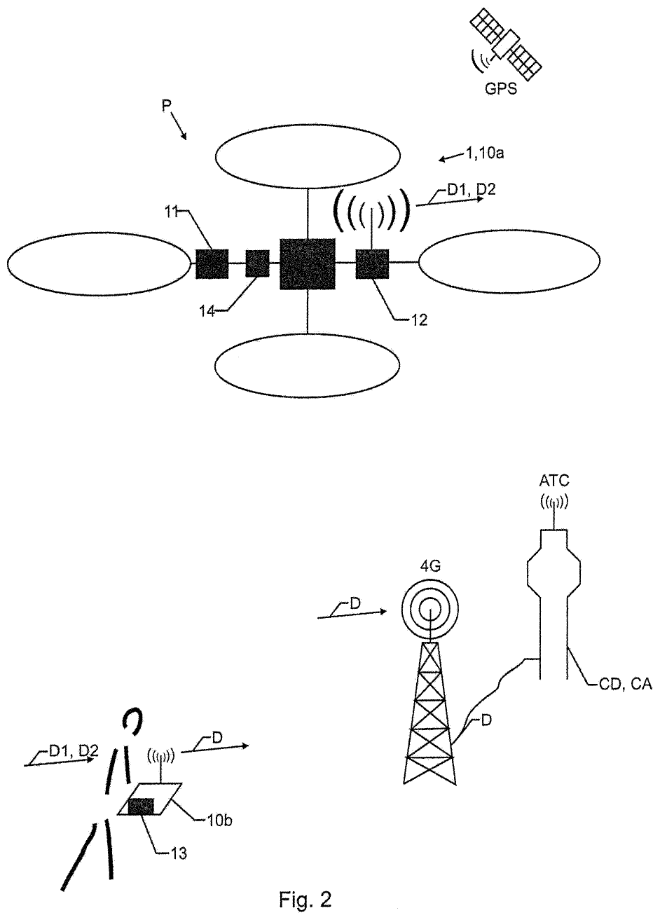

FIG. 2 shows a multirotor 1 comprising a remote identification device 10 according to a second embodiment of the invention. This second embodiment is very similar to the first embodiment as described above with regard to FIG. 1 with the difference that the remote identification device 10 comprises an airborne unit 10a and a ground-based unit 10b as part of the electronic flight controller. First types of data packages D1 and second types of data packages D2 are transmitted from the airborne unit 10a to the ground-based unit 10b. The first type D1 comprise the full three-dimensional position information P (LATITUDE, LONGITUDE, ALTITUDE, see FIG. 5a) while the second type D2 comprise only relative position information (D1+Delta LATITUDE, D1+Delta LONGITUDE, D1+Delta ALTITUDE, see FIG. 5b) with regard to the previously transmitted type-1 position. This helps to conserve bandwidth in areas with lots of radio traffic. The different types D1 and D2 are transmitted with different and variable periodicities based on the position P and velocity of the multirotor 1. Then, the ground based unit 10b reassembles full data packages D and transmits these via a cellphone data connection 4G by means of a connected smartphone to air traffic control ATC. The ground-based unit 10b further comprises a recording device 13 in form of an SD card structured for recording and storing the transmitted data packages for later analysis.

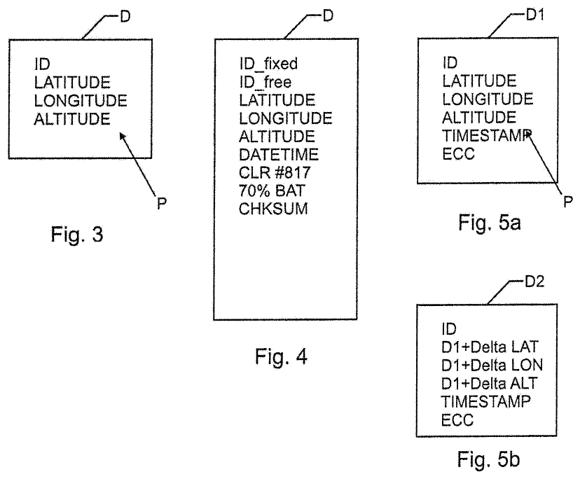

FIG. 3 shows a first example of a data package D as transmitted by a remote identification device 10 according to the invention. The data package D comprises a unique identifier ID of the aircraft and a three-dimensional position P comprising a LATITUDE, LONGITUDE, and ALTITUDE.

FIG. 4 shows a second example of a data package D as transmitted by a remote identification device 10 according to the invention. In this embodiment, further information such as a user-configurable part of the identifier ID_free, a timestamp DATETIME, an ATC-acknowledged clearance CLR #817 for crossing a restricted airspace, a battery level 70% BAT as well as a checksum CHKSUM are transmitted, which improves the information content and situational awareness.

As described above with regard to FIG. 2, FIGS. 5a and 5b show a third example of a first type D1 and a second type D2 of data packages D as transmitted by a remote identification device 10 according to the invention. The first types D1 comprise the full three-dimensional position information P (LATITUDE, LONGITUDE, ALTITUDE, see FIG. 5a) while the second types D2 comprise only relative position information (D1+Delta LATITUDE, D1+Delta LONGITUDE, D1+Delta ALTITUDE, see FIG. 5b) with regard to the position transmitted in the first type data package D1. Additional information comprises a TIMESTAMP and error-correcting codes ECC. Type-1 data packages D1 are transmitted with a periodicity of 1 min or on demand while type-2 data packages D2 are transmitted with a periodicity of 10 sec. Thus, bandwidths is saved.

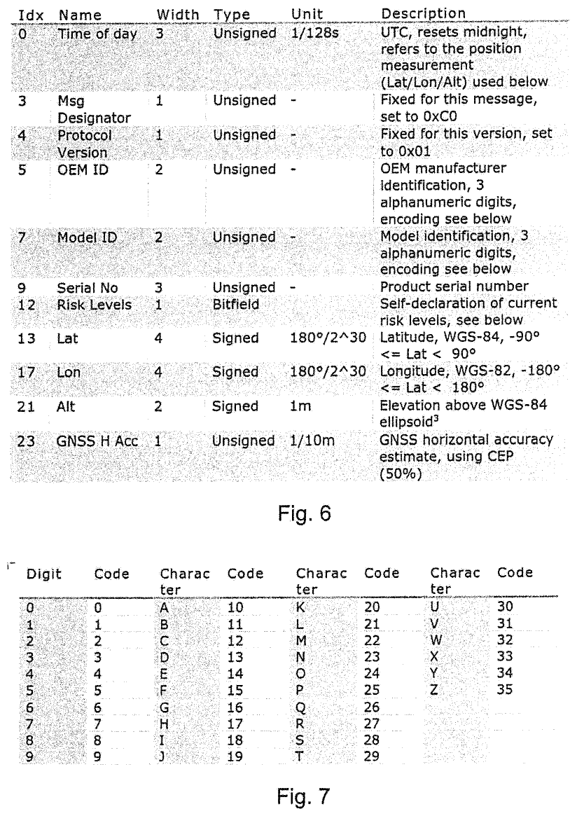

FIG. 6 shows a payload structure, i.e., a structure comprising actual data, not merely protocol overhead, of the data package D. Idx thereby refers to the starting position of the given field, in bytes, relative to the beginning of the payload. Width is in measured in bytes.

The “risk level” field comprises the self-declaration of the Airspace Encounter Category (AEC), Air Risk Category (ARC), and UAS Certification Category as specified in “JARUS Guidelines on Specific Operations Risk Assessment” and “Introduction of a regulatory framework for the operation of unmanned aircraft (EASA)”.

The “OEM Manufacturer ID” and “Model ID” fields allow three alphanumeric uppercase characters. For the OEM Manufacturer ID, an identification as assigned by a competent registration authority is used, which must be globally unique. For the Model ID, an identification that is unique amongst all models from the same manufacturer is used. In both cases, the preferred option is to have manufacturer and model identification for the aircraft itself, but in case of standalone remote identification device for retrofit or in the case of interchangeable tags, this may not be possible or reasonable.

To save bandwidth, the fields are encoded and condensed. The following algorithm is applied:
Let text[i] be the i-th character or digit of the input field, with i between 0 and 2.
Let result be an unsigned 16-bit integer.
Let LUT[ch] return the code given in the lookup table of FIG. 7 for the given input character or digit.
1. result:=0
2. for idx:=0 to 2 do
   a. tmp:=LUT[text[idx]]
   b. result:=result+tmp*(36\hat{ }idx)
3. return result

### Example

The input text “ABC” yields: 10*(360)+11*(361)+12*(362)=10+396+15552=15958=0x3E56.

This helps to save bandwidth which is highly relevant with many air traffic participants.

FIG. 7 shows a lookup table as used for field encoding and condensing as explained before with regard to FIG. 6.

### Description of a Preferred Embodiment

A remote identification device 10 for a multirotor 1 comprises an EGNOS enabled GPS receiver 11 for determining a three-dimensional position P of the aircraft 1 and a radio transmitter 12 operating at 2.4 GHz for periodically transmitting a data package D comprising the determined three-dimensional position P of the aircraft 1, a unique identifier ID of the aircraft 1, and a timestamp. The transmitted data packages D comprise first types D1 carrying the full information as well as second types D2 carrying only relative position data. All data packages D further comprise ECC data and are cryptographically signed. Remote identification devices 10, 10′ on different aircrafts 1,1′ together with the ground based receiver station ATC form a mesh-network by retransmitting foreign data packages. Thus, aircrafts 1,1′ are more easily identified and the data packages can be efficiently used for aircraft registration and law enforcement.

Aspects of the Invention

Aspects of the invention are disclosed in the following clauses:

Clause 1: A remote identification device (10) for an unmanned aircraft (1), comprising:
a positioning device (11) for determining a three-dimensional position (P) of the aircraft (1), and
a transmitter (12) for transmitting a data package (D) comprising the determined three-dimensional position (P) of the aircraft (1) and an identifier (ID) of the aircraft (1),

characterized in that the remote identification device (10) is structured for periodically transmitting said data package (D).

Clause 2: The remote identification device (10) of clause 1 wherein the positioning device (11) comprises a global navigation satellite system (GNSS) receiver,

in particular at least one of a Global Positioning System (GPS) receiver, a Global Navigation Satellite System (GLONASS) receiver, a Galileo receiver, and a Beidou receiver,

and in particular wherein the positioning device (11) comprises a differential GNSS receiver such as at least one of a Wide Area Augmentation System (WAAS) receiver, an European Geostationary Navigation Overlay Service (EGNOS) receiver, and a Multi-Functional Satellite Augmentation System (MSAS) receiver.

Clause 3: The remote identification device (10) of any one of the preceding clauses wherein the positioning device (11) comprises an Inertial Navigation System (INS).

Clause 4: The remote identification device (10) of any one of the preceding clauses wherein the positioning device (11) comprises a receiver for its own position data (P) from a ground-based localization system.

Clause 5: The remote identification device (10) of any one of the preceding clauses structured for receiving an interrogation request from another aircraft (1′) or from a ground-based station (ATC),

and in particular wherein the remote identification device (10) is structured for transmitting said data package (D) after receiving the interrogation request, in particular from air traffic control (ATC).

Clause 6: The remote identification device (10) of any one of the preceding clauses structured for encrypting and/or cryptographically signing at least a part of said data package (D), in particular using an asymmetric and/or a symmetric algorithm.

Clause 7: The remote identification device (10) of clause 6 further comprising a security device (14), in particular comprising a key,

wherein the security device (10) is structured for encrypting and/or cryptographically signing at least said part of said data package (D), and

wherein said security device (14) comprise a protection device against malicious access or extraction.

Clause 8: The remote identification device (10) of clause 7 structured for asymmetrically encrypting and/or signing at least said part of said data package (D), wherein said security device (10) comprises a private key and wherein a public key for decryption and/or verification is stored in a central database/certificate authority (CA).

Clause 9: The remote identification device (10) of any one of the preceding clauses wherein said data package (D) further comprises at least one of
a request for clearance and/or an acknowledgement of clearance,
a parameter of the aircraft (1), in particular a fuel level and/or a battery level,
a planned and/or expected future flight trajectory of the aircraft
a mission status of the aircraft (1),
a collision avoidance dataset, in particular a FLARM dataset, and
a current date and/or timestamp.

Clause 10: The remote identification device (10) of any one of the preceding clauses wherein said identifier (ID) of the aircraft (1) is a unique identifier.

Clause 11: The remote identification device (10) of any one of the preceding clauses wherein said identifier (ID) of the aircraft (1) comprises a fixed part and a user-configurable part.

Clause 12: The remote identification device (10) of any one of the preceding clauses structured for transmitting said data package (D)
with a fixed periodicity,
with a variable periodicity,
with a variable periodicity based on the three-dimensional position (P) of the aircraft (1),
with a variable periodicity based on a velocity of the aircraft (1),
with a variable periodicity based on an acceleration of the aircraft (1),
with a variable periodicity based on a travelled distance of the aircraft (1), in particular a travelled distance after a previous transmitted data package (D),
with a variable periodicity based on a distance of the aircraft (1) to an external position, in particular to an airspace (CTR) or a landmark,
with a variable periodicity based on a NOTAM information or an ATC clearance,
with a variable periodicity based on an air traffic or radio traffic density, and/or
with a variable periodicity based on at least one of a mission profile, a risk profile, and a threat level.

Clause 13: The remote identification device (10) of any one of the preceding clauses structured for transmitting said data package (D)
at a frequency of approximately 868 MHz,
at a frequency of approximately 915 MHz,
at a frequency of approximately 2.4 GHz,
at a frequency of approximately 5.8 GHz, and/or
using an ultra-wideband (UWB) transmitter.

Clause 14: The remote identification device (10) of any one of the preceding clauses structured for transmitting at least a first type of said data package (D1) and a second type of said data package (D2) wherein
the first type of said data package (D1) comprises the determined three-dimensional position (P) of the aircraft (1) and the identifier (ID) of the aircraft (1), and
the second type of said data package (D2) comprises a relative position (P) of the aircraft (1) with regard to the three-dimensional position (P) of the aircraft (1) transmitted in the first type of said data package (D1) or with regard to a three-dimensional position (P) of the aircraft (1) previously transmitted in a second type of said data package (D2).

Clause 15: The remote identification device (10) of clause 14 wherein a first periodicity for the first type of said data package (D1) is different from a second periodicity for the second type of said data package (D2).

Clause 16: The remote identification device (10) of any of the preceding clauses wherein at least a part, in particular an altitude, of the transmitted three-dimensional position (P) of the aircraft (1) is a relative position, in particular with regard to
an altitude above ground (AGL),
an altitude above WGS-84 geoid, or
a takeoff site of the aircraft (1).

Clause 17: The remote identification device (10) of any of the preceding clauses further comprising a radio traffic limiting device, in particular a frequency hopping device, a time slot synchronization device, a listen-before-talk device, and/or a fair spectrum management device.

Clause 18: The remote identification device (10) of any one of the preceding clauses structured for periodically transmitting said data package (D) to a mobile or stationary ground-based station, in particular to air traffic control (ATC).

Clause 19: The remote identification device (10) of any one of the preceding clauses comprising an airborne unit (10a) and a ground-based unit (10b), wherein the airborne unit (10a) and the ground-based unit (10b) are communicatively connected to each other.

Clause 20: The remote identification device (10) of clause 19 wherein the ground-based unit (10b) is structured for periodically transmitting said data package (D), in particular to air traffic control (ATC), in particular via a wireless connection, in particular via a cellphone data connection.

Clause 21: The remote identification device (10) of clause 20 wherein the ground-based unit (10b) comprises and/or is connected to a smartphone and/or an electronic flight controller.

Clause 22: The remote identification device (10) of any one of the preceding clauses further comprising a recording device (13) structured for recording and storing at least one of the transmitted data packages (D), in particular all transmitted data packages (D).

Clause 23: The remote identification device (10) of any one of the preceding clauses wherein at least a part of said data package (D) is Manchester coded.

Clause 24: The remote identification device (10) of any one of the preceding clauses wherein said data package (D) comprises error-detection data, in particular a hash or a checksum.

Clause 25: The remote identification device (10) of any one of the preceding clauses wherein said data package (D) comprises forward error-correcting data.

Clause 26: The remote identification device (10) of any one of the preceding clauses wherein said data package (D) comprises data received from another remote identification device (10′), in particular data indicative of an identifier (ID′), an absolute or relative three-dimensional position, a distance, a Received Signal Strength Indicator (RSSI), a bearing vector, a timestamp, and/or an age.

Clause 27: The remote identification device (10) of any one of the preceding clauses structured to retransmit data received from another remote identification device (10′), in particular for creating a mesh network of remote identification devices (10, 10′).

Clause 28: The remote identification device (10) of clause 27 structured to add additional data to a retransmitted data package, in particular a number of retransmissions.

Clause 29: The remote identification device (10) of any one of the clauses 27 or 28 structured to retransmit the data received from the other remote identification device (10′) using a different frequency or technology, in particular ADS-R or TIS-B, and in particular structured to transform, amend, truncate, or convert the data received from the other remote identification device (10′) before retransmission.

Clause 30: An aircraft (1) comprising a remote identification device (10) of any of the preceding clauses.

Clause 31: The aircraft (1) of clause 30 being selected from the group of an Unmanned Aerial Vehicle (UAV), a drone, an Unmanned Aircraft System (UAS), a Remotely Piloted Aircraft Systems (RPAS), a multirotor, a human passenger carrying UAV, and a weather balloon.

Clause 32: The aircraft (1) of any one of the clauses 30 or 31 being selected from the group of a fully autonomous aircraft, a partially autonomous aircraft, a temporarily autonomous aircraft, a ground-controlled aircraft with a visual line-of-sight to a pilot, and a ground-controlled aircraft without a visual line-of-sight to a pilot.

Clause 33: The aircraft (1) of any one of the clauses 30 to 32 being an unmanned aircraft (1) wherein no human pilot is aboard the aircraft (1).

Clause 34: A method for remotely identifying an aircraft (1), in particular an aircraft of any one of the clauses 30 to 33, in particular using a remote identification device (10) of any one of the clauses 1 to 29, the method comprising the steps of:
by means of a positioning device (11) determining a three-dimensional position (P) of the aircraft (1), and
by means of a transmitter (12) transmitting a data package (D) comprising the determined three-dimensional position (P) of the aircraft (1) and an identifier (ID) of the aircraft (1),
characterized in that the data package (D) is periodically transmitted.

Clause 35: The method of clause 34 comprising a further step of:
determining information relating to a missing or faulty data package (D) using one or more previously received data packages (D), in particular using an extrapolation of a trajectory.

Clause 36: The method of any one of the clauses 34 or 35 comprising further steps of:
receiving said transmitted data package (D) by a mobile or stationary receiver station, in particular a ground-station, and
identifying said aircraft (1) using said received data package (D).

Clause 37: The method of any one of the clauses 34 to 36 comprising at least one of the steps of:
saving said data package (D),
analyzing and/or processing said data package (D), and
retransmitting said data package (D), in particular wirelessly retransmitting said data package (D).

Clause 38: The method of any one of the clauses 34 to 37 wherein said data package (D) is used for at least one of
aircraft fleet management,
liability assessment,
law enforcement purposes,
evidence purposes,
billing,
air traffic management and/or regulation,
performance assessment, in particular pilot performance assessment,
aircraft registration, and
an aircraft logbook.

Clause 39: A system for remote identification of an unmanned aircraft (1), in particular of any one of the clauses 30 to 33, in particular using a method of any one of the clauses 34 to 38, the system comprising:
a first remote identification device (10), in particular of any one of the clauses 1 to 29 arranged at a first aircraft (1), in particular of any one of the clauses 30 to 33, and
a mobile or stationary receiver station for receiving the transmitted data package (D) from the first remote identification device (10).

Clause 40: The system of clause 39 wherein the receiver station comprises a ground-based station, in particular air traffic control (ATC).

Clause 41: The system of any one of the clauses 39 or 40 wherein the receiver station comprises a second aircraft (1′), in particular of any one of the clauses 30 to 33, the second aircraft (1′) in particular comprising a second remote identification device (10′).

Clause 42: The system of any one of the clauses 39 to 41 wherein at least two remote identification devices (10, 10′), in particular of any one of the clauses 1 to 29, are arranged as a mesh-network.

Clause 43: The system of any one of the clauses 39 to 42 further comprising a central database (CD) comprising the identifier (ID) and owner information.

Note:

While there are shown and described presently preferred embodiments of the invention, it is to be distinctly understood that the invention is not limited thereto but may be otherwise variously embodied and practiced within the scope of the following claims.

1.-43. (canceled)

44. A remote identification device for an unmanned aircraft, comprising:
a positioning device for determining a three-dimensional position of the aircraft, and
a transmitter for broadcasting a data package comprising the determined three-dimensional position of the aircraft and a unique identifier of the aircraft,
wherein the remote identification device is structured for periodically broadcasting said data package to a mobile or stationary ground-based receiver station, and
wherein the remote identification device is structured for cryptographically signing at least a part of said data package using an asymmetric cryptographic algorithm.

45. The remote identification device of claim 44, wherein the positioning device comprises a receiver for its own position data from a ground-based localization system.

46. The remote identification device of claim 44, structured for receiving an interrogation request from another aircraft or from a ground-based station,
and wherein the remote identification device is structured for broadcasting said data package after receiving the interrogation request.

47. The remote identification device of claim 44, structured for encrypting at least a part of said data package, using an asymmetric and/or a symmetric algorithm.

48. The remote identification device of claim 44, further comprising a security device, comprising a key,
wherein the security device is structured for encrypting and/or crypto-graphically signing at least said aid part of said data package, and
wherein said security device comprise a protection device against malicious access or extraction.

49. The remote identification device of claim 44, structured for asymmetrically encrypting and/or signing at least said part of said data package, wherein said remote identification device comprises a private key and wherein a public key for decryption and/or verification is stored in a central database/certificate authority.

50. The remote identification device of claim 44, wherein said data package further comprises at least one of
a request for clearance and/or an acknowledgement of clearance,
a fuel level and/or a battery level and/or another parameter of the aircraft,
a planned and/or expected future flight trajectory of the aircraft,
a mission status of the aircraft,
a FLARM dataset or another collision avoidance dataset, and
a current date and/or timestamp.

51. The remote identification device of claim 44, structured for broadcasting said data package
with a fixed periodicity,
with a variable periodicity,
with a variable periodicity based on the three-dimensional position of the aircraft,
with a variable periodicity based on a velocity of the aircraft,
with a variable periodicity based on an acceleration of the aircraft,
with a variable periodicity based on a travelled distance of the aircraft,
with a variable periodicity based on a distance of the aircraft to an air-space, a landmark, or another external position,
with a variable periodicity based on a NOTAM information or an ATC clearance,
with a variable periodicity based on an air traffic or radio traffic density, and/or
with a variable periodicity based on at least one of a mission profile, a risk profile, and a threat level.

52. The remote identification device of claim 44, structured for broadcasting at least a first type of said data package and a second type of said data package wherein
the first type of said data package comprises the determined three-dimensional position of the aircraft and the identifier of the aircraft, and
the second type of said data package comprises a relative position of the aircraft with regard to the three-dimensional position of the aircraft broadcasted in the first type of said data package or with regard to a three-dimensional position of the aircraft previously broadcasted in a second type of said data package.

53. The remote identification device of claim 52, wherein a first periodicity for the first type of said data package is different from a second periodicity for the second type of said data package.

54. The remote identification device of claim 44, further comprising a frequency hopping device, a time slot synchronization device, a listen-before-talk device, a fair spectrum management device, and/or another radio traffic limiting device.

55. The remote identification device of claim 44, comprising an airborne unit and a ground-based unit, wherein the airborne unit and the ground-based unit are communicatively connected to each other, and wherein the ground-based unit is structured for periodically transmitting said data package via a wireless connection.

56. The remote identification device of claim 55, wherein the ground-based unit comprises and/or is connected to a smartphone and/or an electronic flight controller.

57. The remote identification device of claim 44, wherein said data package comprises a hash, a checksum and/or other error-detection data.

58. The remote identification device of claim 44, wherein said data package comprises forward error-correcting data.

59. The remote identification device of claim 44, wherein said data package comprises data received from another remote identification device comprising data indicative of another unique identifier, another absolute or relative three-dimensional position, a distance, a Received Signal Strength Indicator, a bearing vector, a timestamp, and/or an age.

60. The remote identification device of claim 44, structured to rebroadcast data received from another remote identification device for creating a mesh network of remote identification devices.

61. The remote identification device of claim 60, structured to add a number of retransmissions and/or other additional data to a rebroadcasted data package.

62. An unmanned aircraft comprising a remote identification device of claim 44, wherein no human pilot is aboard the aircraft and wherein the unmanned aircraft is selected from the group of an Unmanned Aerial Vehicle, a drone, an Unmanned Aircraft System, a Remotely Piloted Aircraft System, a multirotor, a human passenger carrying UAV, and a weather balloon.

63. A method for remotely identifying a unmanned aircraft comprising a remote identification device comprising (a) a positioning device for determining a three-dimensional position of the aircraft, and (b) a transmitter for broadcasting a data package comprising the determined three-dimensional position of the aircraft and a unique identifier of the aircraft, wherein the remote identification device is structured for periodically broadcasting said data package to a mobile or stationary ground-based receiver station, and wherein the remote identification device is structured for cryptographically signing at least a part of said data package using an asymmetric cryptographic algorithm, wherein no human pilot is aboard the aircraft and wherein the unmanned aircraft is selected from the group of an Unmanned Aerial Vehicle, a drone, an Unmanned Aircraft System, a Remotely Piloted Aircraft System, a multirotor, a human passenger carrying UAV, and a weather balloon,
the method comprising:
by means of the positioning device of the remote identification device of the aircraft determining a three-dimensional position of the aircraft, and
by means of the transmitter of the remote identification device of the aircraft broadcasting a data package comprising the determined three-dimensional position of the aircraft and a unique identifier of the aircraft, wherein the data package is periodically broadcasted to a mobile or stationary ground-based receiver station,
receiving said broadcasted data package by the mobile or stationary ground-based receiver station, and
identifying said aircraft using said received data package.

64. The method of claim 63, used for at least one of
aircraft fleet management,
liability assessment,
law enforcement purposes,
evidence purposes,
billing,
air traffic management and/or regulation,
performance assessment,
aircraft registration, and
an aircraft logbook.

65. A system for remote identification of an unmanned aircraft, the system comprising:
a remote identification device comprising (a) a positioning device for determining a three-dimensional position of the aircraft, and (b) a transmitter for broadcasting a data package comprising the determined three-dimensional position of the aircraft and a unique identifier of the aircraft, wherein the remote identification device is structured for periodically broadcasting said data package to a mobile or stationary ground-based receiver station, and wherein the remote identification device is structured for cryptographically signing at least a part of said data package using an asymmetric cryptographic algorithm,
the remote identification device being arranged at an unmanned aircraft, wherein no human pilot is aboard the aircraft and wherein the unmanned aircraft is selected from the group of an Unmanned Aerial Vehicle, a drone, an Unmanned Aircraft System, a Remotely Piloted Aircraft System, a multirotor, a human passenger carrying UAV, and a weather balloon, and
a mobile or stationary ground-based receiver station for receiving the broadcasted data package from the remote identification device.

66. The system of claim 65, further comprising a central database comprising a unique identifier of the aircraft, owner information, and a public key for verification of the broadcasted data package from the remote identification device.
